(19) United States
(12) Patent Application Publication
(10) Pub. No.: US 2008/0304497 A1
(43) Pub. Date: Dec. 11, 2008

(54) Methods of route control in communications network

(75) Inventors: K. J. Viswanath, Bangalore (IN); Sirugudi Narendra, Bangalore (IN); Kuhikar Sanjay, Bangalore (IN)

Correspondence Address: HARNESS, DICKEY & PIERCE, P.L.C., P.O. BOX 8910, RESTON, VA, 20195, US

(73) Assignee: Lucent Technologies Inc.

(21) Appl. No.: 11/806,901

(22) Filed: Jun. 5, 2007

(51) Int. Cl. H04L 12/56

(52) U.S. Cl. 370/401

(57) ABSTRACT

Methods of route control in a communications network are provided. In an example, routing information is received from a first router, the received routing information reporting at least one routing path between a first autonomous system and a second autonomous system. Next, a determination is made as to whether the reported routing path is superior to a previously known routing path. Filter instructions are sent to a given router instructing the given router not to report routing paths between the first autonomous system and the second autonomous system unless a routing path superior to one of the at least one reported routing path is received based on the determining step. In another example, filter instructions are received, from a given router, requesting a blockage of route reporting for routing paths between a first autonomous system and a second autonomous system which are inferior to a first routing path threshold. A determination is made as to whether to report known routes to the given router based on the first filter instructions. Second filter instructions are received, from the given router, the received second filter instructions requesting a modification to the first filter instructions.

### BACKGROUND

1. Field

Example embodiments are related generally to methods of route control in a communications network.

2. Description

The Border Gateway Protocol (BGP) is the core routing protocol of the Internet. BGP works by maintaining a table of Internet Protocol (IP) networks or ‘prefixes’ which designate network reachability among autonomous systems (ASs). BGP is a path vector protocol. BGP does not use traditional interior gateway protocol (IGP) metrics, but rather determines routing decisions based on path, network policies and/or rulesets. Internal BGP (IBGP) is a path vector routing protocol where BGP is performed within a single autonomous system. External BGP (EBGP) is a path vector routing protocol, used for exchanging routing information between two or more autonomous systems in an IP based data network.

An AS Path list is an attribute to describe a path of the EBGP route. An AS path list typically includes each autonomous system (AS) through which the EBGP route is reachable. The number of autonomous systems present in the list is defined as the AS Path length.

In a conventional EBGP system, EBGP routers at each autonomous system “advertise” or report local IP routes to EBGP routers at other autonomous systems. EBGP routers advertise local IP routes by sharing route information with neighboring EBGP routers (e.g., transmitting route information from a sending EBGP router to one or more other EBGP routers), including path attributes (e.g., indicating an origin of the route), AS distance (e.g., a number of ASs between an origin node and a destination node on a given path or route), a preference of routes, etc. The receiving EBGP router uses the shared route information to update its own route preferences and to further distribute the shared route information to other neighboring EBGP routers, and so on.

FIG. 1 illustrates a conventional communication system 100 including a plurality of interconnected autonomous systems. The communication system 100 includes first through sixth autonomous systems AS1, AS2, AS3, AS4, AS5 and AS6. Autonomous systems AS1, AS2, AS3, AS4, AS5 and AS6 are connected to routers R1, R2, R3, R4, R5 and R6, respectively.

Referring to FIG. 1, connections between the routers R1 through R6 are illustrated as links, which are denoted as Lnm, wherein n and m represent numbers corresponding to the routers included in a given connection. For example, as shown in FIG. 1, the link between R1 and R2 is denoted as “L12”, the link between R3 and R5 is denoted as “L35”, and so on.

Referring to FIG. 1, AS1 includes networks X/24 and Y/24, and AS6 includes networks M/16 and N/16. Accordingly, assume router R1 at AS1 and router R6 at AS6 advertise their respective networks X/24, Y/24, M/16 and N/16, respectively, to router R4 within the communication system 100 of FIG. 1. In this example, the network routing table, or BGP Loc—routing information database (RIB), at router R4 is established as shown below in Table 1.

TABLE 1

| Route | | | |
|---|---|---|---|
| Number | Network Prefix | AS Path | Path Length |
| 1. | X/24 | 2, 1 | 2 |
| 2. | Y/24 | 2, 1 | 2 |
| 3. | M/16 | 2, 1, 6 | 3 |
| 4. | N/16 | 2, 1, 6 | 3 |

As shown in Table 1, using route #1 as an example, router R4 can reach network X/24 at AS1 by traversing R2 at AS2 and then R1 at AS1. Thus, the AS Path is (2,1) because, in order to reach network X/24 from router R4 in accordance with Table 1, router R2 is traversed followed by router R1. The path length is two (2) because two autonomous systems or routers are traversed before reaching the destination network (i.e., X/24).

Now further assume that router R5 advertises its network routing table to router R4. While not discussed in detail for the sake of brevity, it will be appreciated that router R4 may also advertise its network routing table (e.g., see Table 1) to router R5 at this time, and the network routing table of router R5 may be updated accordingly. The network routing table at router R4 is updated, as shown in Table 2 below.

TABLE 2

| Route | Network | | | |
|---|---|---|---|---|
| Number | Prefix | AS Path | Path Length | Comment |
| 1. | X/24 | 2, 1 | 2 | |
| 2. | Y/24 | 2, 1 | 2 | |
| 3. | M/16 | 2, 1, 6 | 3 | |
| 4. | N/16 | 2, 1, 6 | 3 | |
| 5. | X/24 | 5, 3, 1 | 3 | Inferior Route |
| 6. | Y/24 | 5, 3, 1 | 3 | Inferior Route |
| 7. | M/16 | 5, 3, 1, 6 | 4 | Inferior Route |
| 8. | N/16 | 5, 3, 1, 6 | 4 | Inferior Route |

Referring to Table 2, it will be appreciated that the paths reported by router R5 to router R4 are each inferior, or have a higher path length, then the corresponding paths already known at router R4. Thus, unless a superior path later becomes inactive or disabled, the inferior paths reported by router R5 to router R4 are generally ignored by the router R4.

Network routing tables which only include redundant or inferior paths waste system resources (e.g., bandwidth, processing time making comparisons to inferior routes, etc.). Thus, system administrators may block network routing table reporting between routers for which inferior or equal cost (e.g., duplicative in terms of AS path length) route reporting is expected. As used herein, “equal cost” route reporting may include either duplicative reporting (e.g., reporting of the same previously known route) or reporting of a different route having the same AS path length. For example, in FIG. 1, the link L45 between routers R4 and R5 may block route reporting for routes to/from AS1/R1 and/or AS6/R6 in either direction (e.g., from router R4 to router R5 or from router R5 to R4).

FIG. 2 illustrates another conventional communication system 200. In particular, FIG. 2 illustrates different interconnections among the autonomous systems AS1 through AS6. From a review of FIG. 2, it will be appreciated that route reporting on certain links within the communication system 200 is likely to be redundant (e.g., equal cost route reporting, inferior route reporting, etc.). For example, the following links listed in Table 3 (below) may carry redundant traffic:

TABLE 3

| Link | Updates to be blocked |
|---|---|
| L16 | Updates related to AS2, AS3, AS4 |
| L12 | Updates related to AS6 and AS5 |
| L26 | Updates related to AS1 |
| L46 | Updates related to AS2, AS5 and AS3 |
| L24 | Updates related to AS1 and AS6 |
| L45 | Updates related to AS1 and AS6 |

System administrators may block the links for which redundant route reporting is expected via “static” outbound route filters (ORFs), which are applied at the router-level. For example, the ORFs may be configured to instruct an associated router to block the mentioned updates for the listed links as described above in Table 3. Because the ORFs are statically determined by the system administrator, the ORFs are not robust in the sense that it may be difficult to respond to a change to the communication system 100. For example, referring to FIG. 1 and Tables 1 and 2, if router R4 advertises an ORF for M/16 on router R5 (e.g., R4 requests R5 not to send updates related to M/16) and if link L24 becomes inactive (e.g., which is on R4's best path to M/16), R4 will not receive an update for M/16 from R5 until the system administrator manually instructs R4 to remove the ORF.

### SUMMARY OF THE EXAMPLE EMBODIMENTS

An example embodiment is directed to a method of route control in a communication network, including receiving, from a first router, routing information that reports at least one routing path between a first autonomous system and a second autonomous system, first determining whether the reported routing path is superior to a previously known routing path and sending, to a given router, filter instructions that prohibit the given router from reporting routing paths between the first autonomous system and the second autonomous system unless a routing path is determined to be superior to at least one of the previously known routing path and the at least one reported routing path.

Another example embodiment is directed to a method of route control in a communication network, including receiving first filter instructions, from a given router, requesting a blockage of route reporting for routing paths between a first autonomous system and a second autonomous system which are inferior to a first routing path threshold, first determining whether to report known routes to the given router based on the first filter instructions and receiving second filter instructions, from the given router, the received second filter instructions requesting a modification to the first filter instructions.

### BRIEF DESCRIPTION OF THE DRAWINGS

Example embodiments will become more fully understood from the detailed description provided below and the accompanying drawings, wherein like elements are represented by like reference numerals, which are given by way of illustration only and thus are not limiting of the present invention and wherein:

FIG. 1 illustrates a conventional communication system including a plurality of interconnected autonomous systems.

FIG. 2 illustrates another conventional communication system.

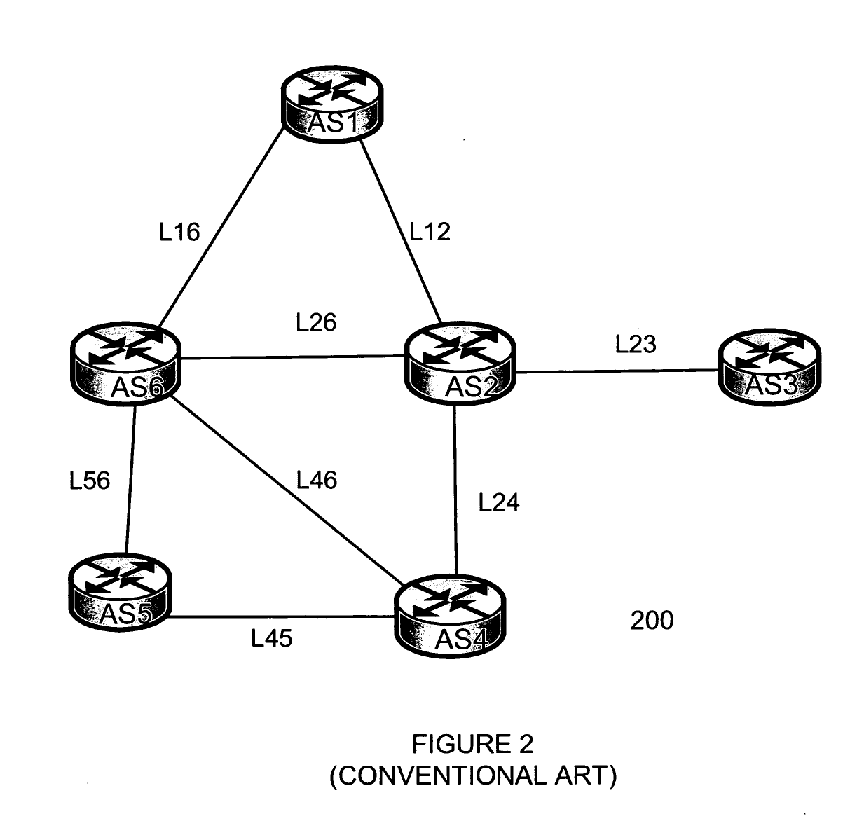

FIG. 3 illustrates a dynamic outbound route filter (DORF) generation process performed within the communication system of FIG. 1 according to an example embodiment.

FIG. 4 illustrates a DORF handling process according to an example embodiment.

FIG. 5 illustrates a DORF updating process according to another example embodiment.

FIG. 6 illustrates the communication system of FIG. 1 after a new link becomes active according to an example embodiment.

### DETAILED DESCRIPTION OF EXAMPLE EMBODIMENTS

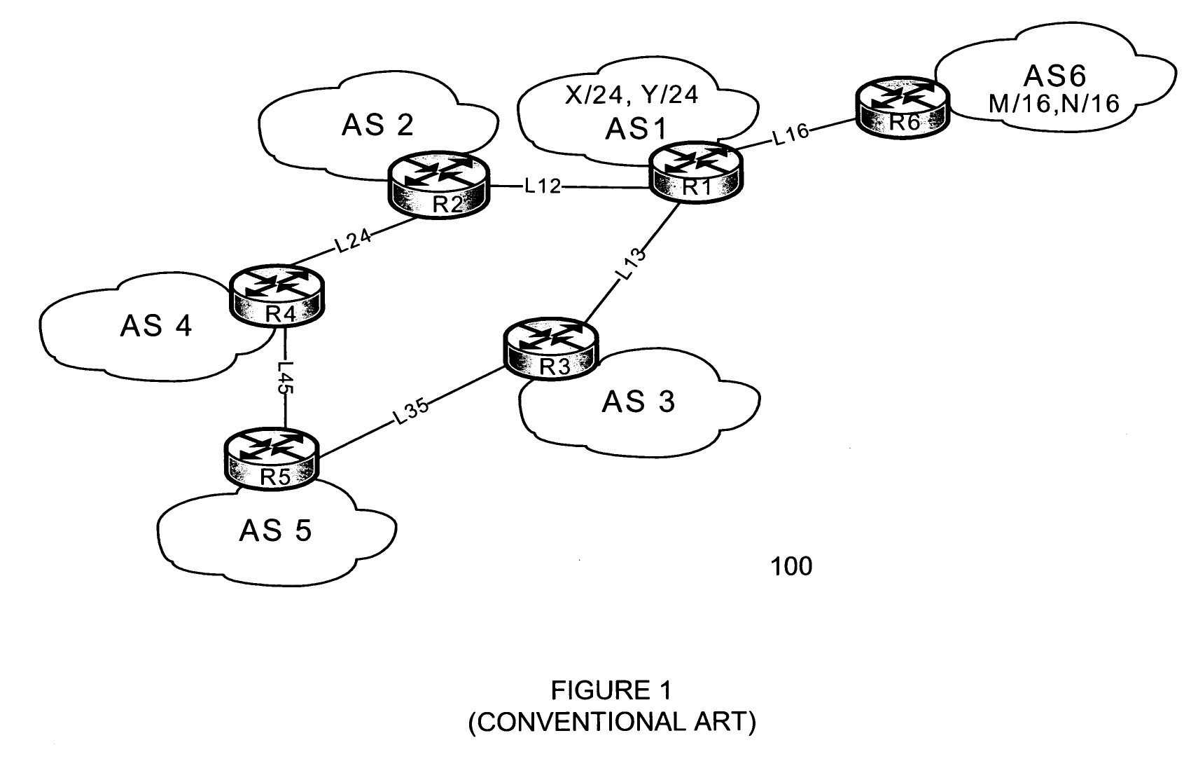

In order to better understand the example embodiments, an example process of generating and distributing dynamic output route filters (DORFs) within a communication system will be described, followed by an example process of withdrawing/removing DORFs within the communication system. For example purposes only, the example DORF processes will be hereinafter described with respect to the conventional communication system 100 of FIG. 1. However, it will be readily appreciated that the example DORF process may alternatively be employed within any communication system including routing paths between multiple network nodes (e.g., External Border Gateway Protocol (EBGP) systems, etc.).

### Dynamic Outbound Route Filters (DORFs)

As described in the Background section, in conventional EBGP communication systems, system administrators are required to manually review links between autonomous systems (ASs) and to block reporting for certain paths or routes within the communication (e.g., by issuing “static” outbound route filters (ORFs)) over links for which reporting is expected to be redundant (e.g., links associated with inferior routes, equal routes, etc.). However, as systems typically do not remain constant during operation, a blocked route initially associated with inferior path reporting may later be associated with a best path. Accordingly, conventional systems respond to dynamic system changes with manual overrides, which is a costly and inefficient process.

Example embodiments are directed to dynamic ORFs (DORFs). A DORF includes a first parameter indicating an intersecting autonomous system (e.g., AS1, AS2, etc.) and a shortest known distance to that intersecting autonomous system from the issuer of the DORF.

Basically, DORFs are “filter instructions” for a router or routers receiving the DORF. The DORFs which are active in the network routing table of each respective router are used to determine whether a route which becomes known to each router is reported to the issuer of the DORF. While example embodiments are described below as directed to DORFs having the format as given above (e.g., AS path length and shortest known distance to an intersecting AS from the issuer of the DORF), it will be appreciated that DORFs or filter instructions in other example embodiments may be configured differently while still allowing for dynamic updating of route reporting permissions.

As will be described in greater detail below, DORFs allow autonomous systems within a communication network to respond dynamically to superior routes which become available during operation and/or to lost superior routes which are no longer available during operation by selectively issuing and/or withdrawing the DORFs.

### DORF Generation and Distribution Process

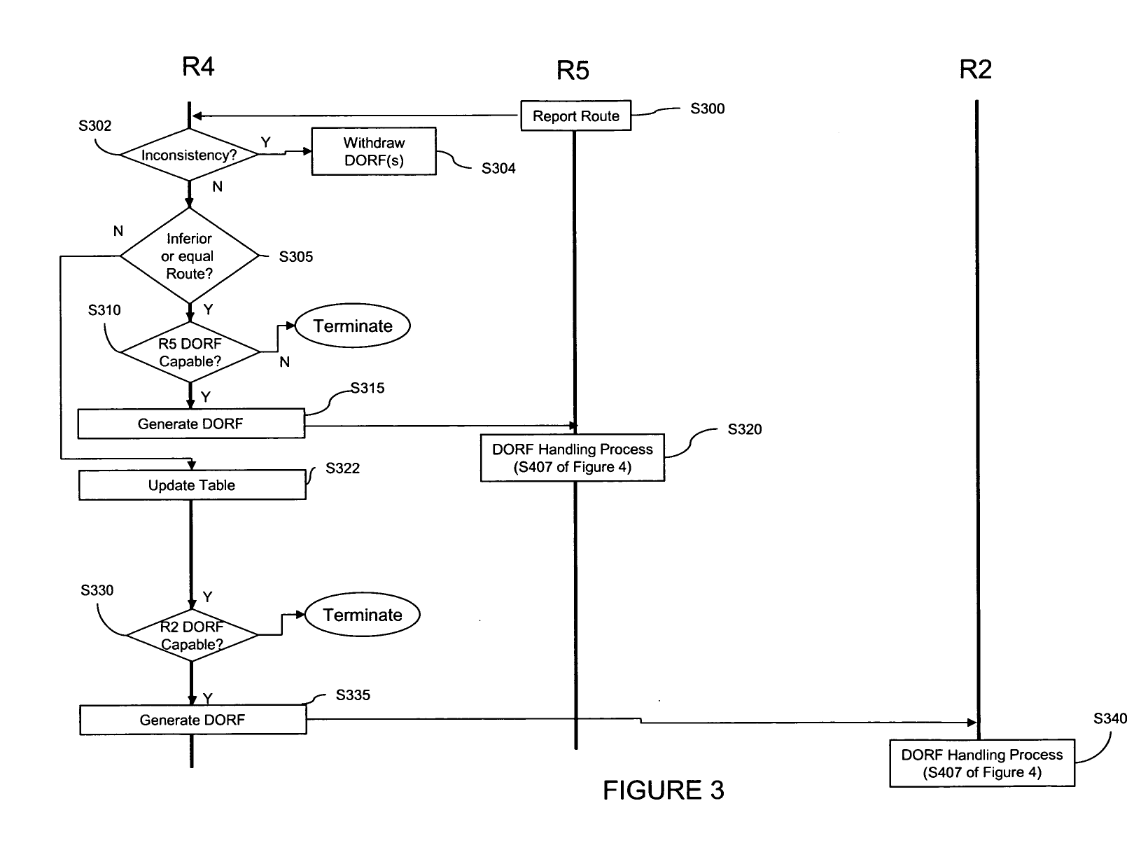

FIG. 3 illustrates a DORF generation process performed within the communication system of FIG. 1 according to an example embodiment. In particular, FIG. 3 illustrates a DORF generated at router R4 within autonomous system AS4 and shared with router R5 and/or router R2 of FIG. 1. However, it will be appreciated that other example embodiments may be directed to a DORF generated at and/or shared between any routers within the communication system 100.

In step S300 of FIG. 3, router R5 reports at least one route to the router R4. For example, router R5 may transfer its entire network routing table to router R4. In another example, router R5 may transfer information associated with less than all (e.g., one) route included within its network routing table to router R4.

In step S302, router R4 evaluates the reported routes from step S300 to determine whether there is an inconsistency between the reported routes and the routes known to router R4 in its network routing table. For example, if the reported routes include different distances or path lengths to the same AS from the same neighbor router, an inconsistency (e.g., with respect to the DORF) may be determined to have occurred.

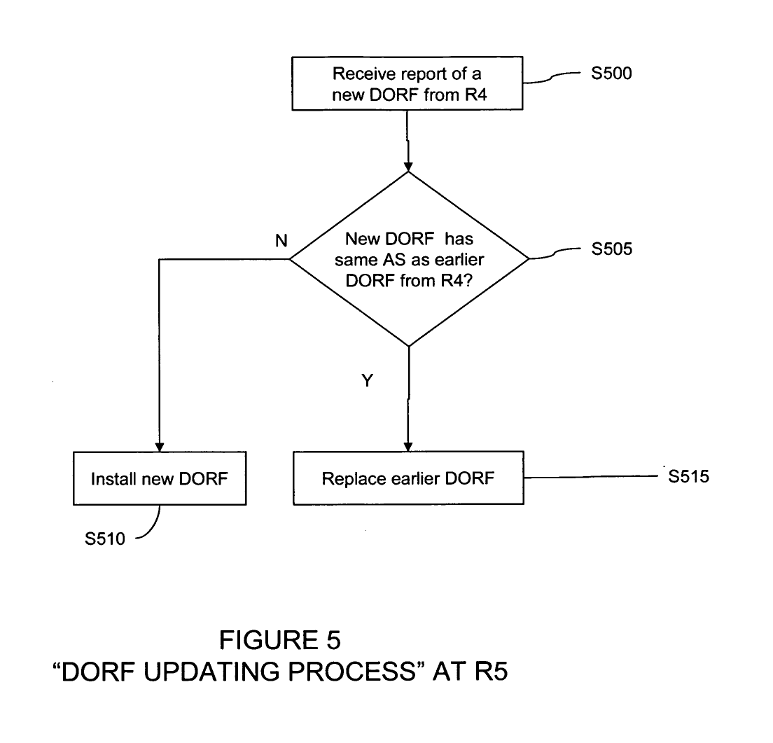

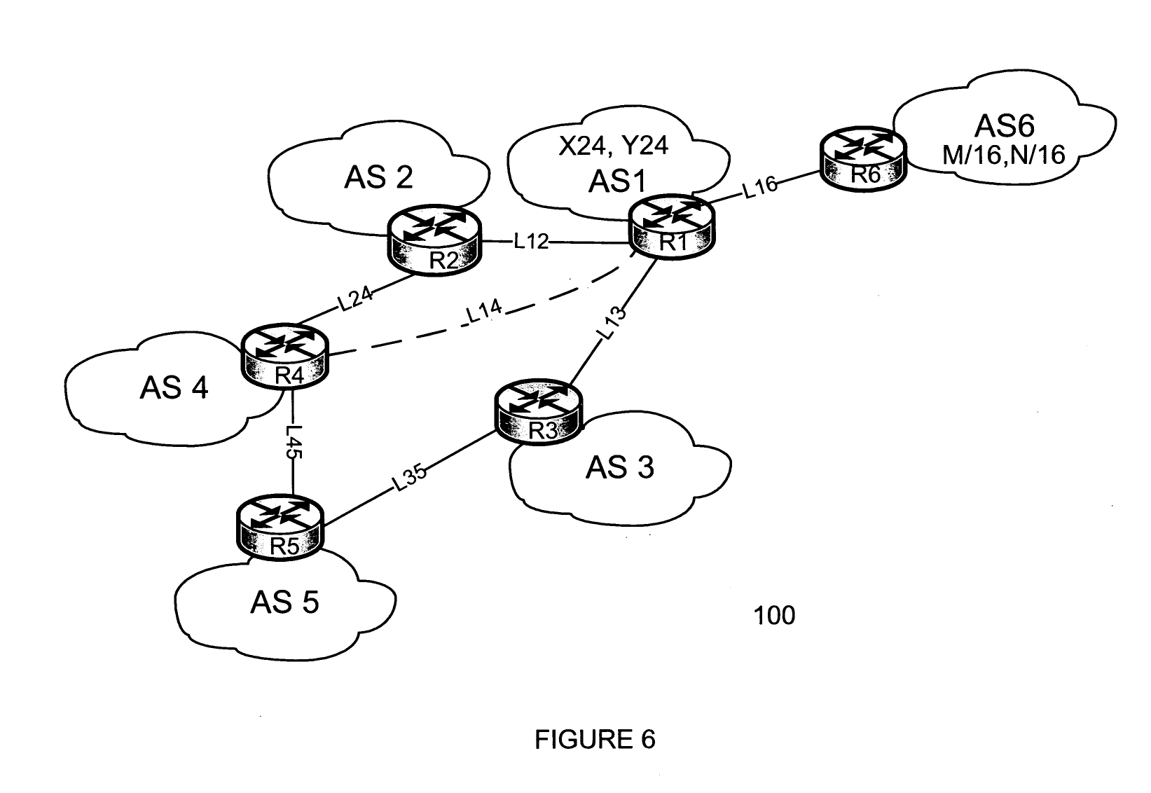

If an inconsistency is determined to have occurred in step S302, all DORFs affected by the inconsistency are “withdrawn” (e.g., removed) in step S304. For example, an inconsistency may be introduced by a given router to dictate the preferred or superior path. Accordingly, the DORF is withdrawn because the router reporting the inconsistent route is determined to desire a certain path to be preferred based on its local policy. In an example, referring to FIG. 1, if router R4 receives X/24 with ASLength=3 over L24 and Y/24 with ASLength=2 on the same link L24, the DORF for X/24 and Y/24 is withdrawn from R2 and R5 and no DORF is advertised (e.g., sent to one or more neighbor routers). For example, inconsistent routes may occur if a given router manipulates its reported routes by adding its ASNumber more than once in certain routes to make a route appear inferior. In an example, this rule applies only if the autonomous systems after the intersecting AS (e.g., an autonomous system present in the DORF) manipulates the route. For example, referring to FIG. 1, if a route to M/16 route is manipulated by R6, the DORF is not affected and the inconsistency will not result in withdrawal. DORF withdrawal is discussed in greater detail below with reference to FIGS. 5 and 6.

Otherwise, in step S302, if no inconsistency is determined to have occurred, the process advances to step S305. In step S305, router R4 analyzes the reported route to determine whether the reported route is inferior or equal to a corresponding route already known to router R4 (e.g., a route already present within router R4's network routing table). In an example, a first route is determined to be “inferior” to a second route if the first route includes a higher number of intervening autonomous systems between a given source router and a given destination router, or AS path length, as compared to the second route between the same source and destination router.

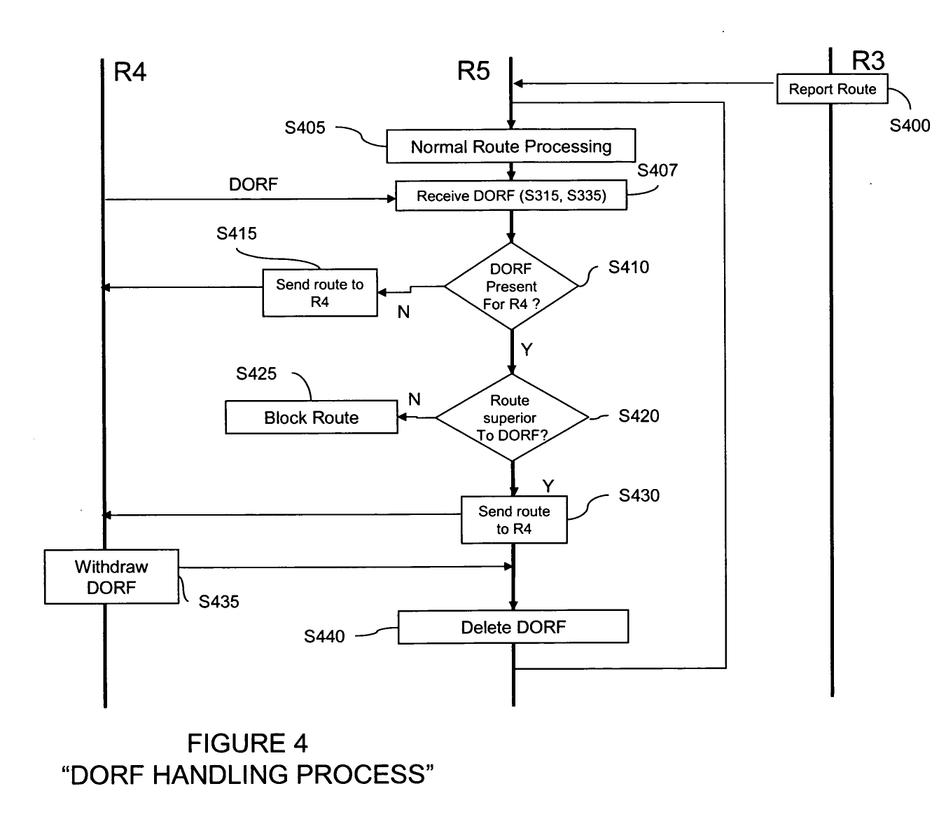

If router R4 determines that the reported route is inferior to R4's corresponding local route, the process advances to step S310. In step S310, router R4 determines whether router R5 is “DORF capable”. In an alternative example, the “DORF capable” determination of step S310 may be performed when the EBGP peer relationship is established between two routers (e.g., routers R4 and R5), and need not be performed each time a route is reported from another router. In an example, router R5 is determined to be DORF capable if router R5 is configured to execute a DORF handling process (e.g., see the example DORF handling process described below with respect to FIG. 4). If router R4 determines that router R5 is not DORF capable, router R4 takes no action and does not generate a DORF, and the process of FIG. 3 terminates (e.g., because router R4 assumes that router R5 would simply ignore any received DORFs). Otherwise, if router R4 determines that router R5 is DORF capable, the process advances to step S315.

In step S315, router R4 generates a DORF for the reported route which is determined to be inferior and sends the generated DORF to router R5. In step S315, the DORF includes a first autonomous AS from the intersection of an inferior route (e.g., the newly reported route) and superior route (e.g., the previously known route), and a shortest known distance to the first AS in the intersection set. For example, referring to FIG. 1, in Table 2 (see Background section), router R4 maintains two entries for routes to network M/16:

M/16 2,1,6(Path Length 3)

M/16 5,3,1,6(Path Length 4)

Accordingly, [5,3,1,6(Path Length 4)] is the inferior path because a path length of 4 is greater than a path length of 3. The intersection or overlapping portion of the two AS paths is (1,6), and the shortest known AS distance to the first AS path in the intersection set (i.e., AS1) from R4 is Path Length 2. Thus, in this example, router R4 generates a DORF in step S315 with (AsNo=1, ASPathLength=2).

In step S320, router R5 executes a DORF handling process (e.g., see step S407 of FIG. 4 wherein a DORF is received by router R5, for example, as generated in step S315 of FIG. 3). The DORF handling process performed in step S320 at router R5 is described in greater detail below with respect to FIG. 4.

Returning to step S305, if router R4 determines that the reported route is not inferior or equal to R4's corresponding local route, the process advances to step S322. In step S322, router R4 updates its network routing table to add the route reported in step S300 (e.g., by replacing the previous route corresponding to the newly reported route, by adding the newly reported route in addition to the previous corresponding route, etc.).

After updating the network routing table in step S322, the process advances to step S330. In step S330, router R4 determines whether the router that previously reported the known route to the router R4 is “DORF capable”. For purposes of example only, it will be assumed that router R2 reported the previously known route to the router R4. In an example, router R2 is DORF capable if router R2 is configured to execute a DORF handling process (e.g., see the example DORF handling process described below with respect to FIG. 4). If router R4 determines that router R2 is not DORF capable, router R4 takes no action and does not generate a DORF, and the process of FIG. 3 terminates (e.g., because router R4 assumes that router R2 would simply ignore any received DORFs). Otherwise, if router R4 determines that router R2 is DORF capable, the process advances to step S335.

In step S335, router R4 generates a DORF for the previously known route and sends the generated DORF to router R2. As discussed above with respect to step S315, the DORF includes a first autonomous AS from the intersection of an inferior route and a superior route, and a shortest known distance to the first AS in the intersection set. However, in step S335; the previously known route is the inferior route and the newly reported route from router R4 is the superior route.

For example, assuming the previously known route is [5,3,1,6(Path Length 4)] and the newly reported route is [2,1,6(Path Length 3)], the intersection or overlapping portion of the two AS paths is (1,6), and the shortest known AS distance to the first AS path in the intersection set (i.e., AS1) is from R4 (i.e., the issuer of the DORF) is 2. Thus, in this example, router R4 generates a DORF in step S335 with (AsNo=1, ASPathLength=2).

Once the DORF generated in step S335 is received by router R2, router R2 executes a DORF handling process in step S340, which is described below in greater detail with respect to FIG. 4 (e.g., see step S407 of FIG. 4 wherein a DORF is received by router R5, for example, as generated in step S335 of FIG. 3).

### DORF Handling Process

FIG. 4 illustrates a DORF handling process according to an example embodiment. In an example, the DORF handling process of FIG. 4 is performed at a router, such as one or more of routers R4, R5, etc., of FIG. 1 (e.g., any router having received one or more DORFs). For example purposes, the process of FIG. 4 is below described as performed at router R5.

In the example embodiment of FIG. 4, in step S400, router R3 reports a new route to router R5. In step S405, router R5 executes a “normal” route update process, which does not take any DORFs into account. The normal route update process is well-known in the art. For example, the normal route update process may correspond to route reporting protocols where no ORF is established in the conventional art. In another example, the normal route update process may include sharing the network routing table of router R5 with the neighboring routers of router R5 (e.g., R4 and R3) whenever the network routing table of router R5 changes.

In step S407, router R5 receives a DORF from router R4. For example, the DORF received by router R5 in step S407 may correspond to a DORF generated in step S315 of FIG. 3, or alternatively to a DORF generated in step S335 of FIG. 3.

In step S410, router R5 determines whether a DORF for R4 is present (e.g., from router R4 at step S315 of FIG. 3). If router R5 determines that a DORF is not present for router R4 then in step S415 it sends the route to R4. If a DORF is present for R4 but the AS path of the route received does not include the AS number present in the DORF, the process advances to step S415 and proceeds as if the DORF is not present. Otherwise, if router R5 determines that a DORF is present for R4 and the AS path list of routes received includes the DORF's AS, then the process advances to step S420. Accordingly, in the example embodiment of FIG. 4, because router R5 receives the DORF from router R4 in step S407, the process advances to step S420.

In step S420, router R5 determines if the AS path list of routes received have superior reachability to an AS present in the DORF. If the route received (e.g., at step S300 from R3) has inferior or equal reachability to the AS present in the DORF, the process advances to step S425. In step S425, the reported route is blocked and not sent to R4. For example, if DORF (AsNo=1, ASPathLength=2) has been sent from router R4 to router R5, and the route is a route to AS1 received from R3, R5 compares the path length of the received route with 2 (e.g., because ASPathLength=2) and if it is not less than 2 then the route is blocked; otherwise, the process advances to step S430.

In step S430, router R5 sends the route to R4. In step S435, R4 receives the reported route and determines the reported route to be superior to a corresponding previously known route, and issues a withdrawal of the DORF. In step S440, after receiving the DORF withdrawal request, router R5 deletes the DORF for R4.

It will be appreciated that the DORF handling process of FIG. 4 is executed for each route received from any other router connected to R5 other than R4 in the manner described above with respect to router R3.

After router R5 removes (e.g., deletes) the DORF in step S440, the process returns to step S405, where the new network routing table (Rib-Loc-Out) containing the newly advertisable routes (e.g., some of which may have been previously blocked by the withdrawn DORF) to the withdrawer of the DORF (e.g., the router requesting DORF withdrawal) may be re-evaluated to determine whether any previously blocked routes require reporting.

In another example, if the new DORF corresponds to a route associated with a previously received DORF, the new DORF may replace the old DORF. For example, if a new link becomes active which has a shorter path length to a given AS than an old link, new DORFs may be issued by one or more routers, and routers receiving the new DORFs may update/replace any old DORFs associated with the old link with the new DORFs.

### Practical Scenarios

As will be appreciated by one of ordinary skill in the art, DORFs are “dynamic” in the sense that any router issuing a DORF may later request that the issued DORF be withdrawn.

In an example, as discussed above with respect to step S302 of FIG. 3, a router may withdraw all DORFs associated with inconsistent routes because the router may suspect that one or more reported routes are inaccurate (e.g., due to manipulation of routing information, etc.).

In another example, if a new link provides a new connection having a shorter path length than an old connection, DORFs may be withdrawn and updated to accommodate for the new link. An example of such a scenario is described below with respect to FIGS. 5 and 6.

FIG. 5 illustrates a DORF updating process according to another example embodiment. For example purposes, the process of FIG. 5 will be described as performed at router R5.

FIG. 6 illustrates the communication system 100 of FIG. 1 after a new link becomes active according to an example embodiment. The example embodiment of FIG. 6 is described below under the assumption that network routing tables at each of the routers R1 through R6 are initially established based on the communication system 100 of FIG. 1 before link L14 is active.

In the example embodiment of FIGS. 5 and 6, a new link L14 is established between routers R1 and R4. Accordingly, returning to the process of FIG. 3, router R5 is notified of the new link L14 (e.g., in step S300) and router R4 generates a DORF (AsNo=1, ASPathLength=1) in step S335, and then sends DORF (AS1,1) to neighboring routers R2 and R5.

Next, assume that routers R2 and R5 have already received a DORF (AS1, 2) from router R4, and routers R2 and R5 receive the new DORF at step S500 of FIG. 5. Step S505 of FIG. 5 (e.g., performed at each of routers R2 and R5 separately) determines that the new DORF has been received, and determines that the new DORF (AS1, 1) will replace the old DORF (AS1, 2). In step S515, the old DORF (AS1, 2) is withdrawn and replaced with the new DORF (AS1, 1) (e.g., the network routing tables at R2 and R5 are “updated” by replacing the old DORF with the new DORF). In an alternative example, if the AS parameter in the old DORF and new DORF is determined not to be the same in step S505 (e.g., if the new DORF is (AS1, 1) and the old DORF is (AS3, 3), etc.), the new DORF is installed without replacing the old DORF in step S510 (e.g., the network routing tables at R2 and R5 are “updated” by adding the new DORF without replacing the new DORF).

In another example, assume all routes having a given path length to a given AS in the network routing table of router R4 become inactive or disabled, and that router R4 previously issued DORFs (given AS, given path length) to neighboring routers. In this example, router R4 withdraws the previously issued DORFs from the neighboring routers in order to obtain new routes to the given AS.

Example embodiments being thus described, it will be obvious that the same may be varied in many ways. For example, while example embodiments are above described as performed within the communication system 100 of FIGS. 1 and/or 5, it is understood that other example embodiments of may be performed within any communication system (e.g., a EBGP system).

Such variations are not to be regarded as a departure from the spirit and scope of the example embodiments and all such modifications as would be obvious to one skilled in the art are intended to be included within the scope of the invention.

What is claimed:

1. A method of route control in a communication network, comprising:
receiving, from a first router, routing information that reports at least one routing path between a first autonomous system and a second autonomous system;
first determining whether the reported routing path is superior to a previously known routing path; and
sending, to a given router, filter instructions that prohibit the given router from reporting routing paths between the first autonomous system and the second autonomous system unless a routing path is determined to be superior to at least one of the previously known routing path and the at least one reported routing path.

2. The method of claim 1, wherein the sending step sends the filter instructions to a second router instructing the second router not to report routing paths between the first autonomous system and the second autonomous system unless a routing path is determined to be superior to the at least one reported routing path based on the first determining step.

3. The method of claim 1, wherein the sending step sends the filter instructions to the first router instructing the first router not to report routing paths between the first autonomous system and the second autonomous system unless a routing path is determined to be superior to the previously known routing path based on the first determining step.

4. The method of claim 1, further comprising:
second determining whether the given router is expected to be responsive to filter instructions; and
performing the sending step if the second determining step determines that the given router is expected to be responsive to filter instructions.

5. The method of claim 1, further comprising:
second determining whether the reported routing path is inconsistent with the previously known routing path;
withdrawing filter instructions associated with routing paths between the first and second autonomous systems if the second determining step determines an inconsistency to be present; and
performing the first determining and sending steps if the second determining step determines an inconsistency is not present.

6. The method of claim 1, further comprising:
updating a network routing table to include the reported routing path if the first determining step determines that the reported routing path is superior to the previously known routing path.

7. The method of claim 6, wherein the updating step removes the previously known routing path from the routing table.

8. The method of claim 1, wherein the filter instructions include a system identifier and a path length.

9. The method of claim 8, wherein the system identifier identifies a given autonomous system and the path length indicates a shortest known path length to the given autonomous system.

10. The method of claim 8, wherein the given autonomous system is an intersecting autonomous system present within both the reported routing path and the previously known routing path.

11. The method of claim 9, wherein the path length indicates a shortest known path length from the first autonomous system to the given autonomous system.

12. The method of claim 11, wherein the receiving, first determining and sending steps are performed at a router positioned at the first autonomous system.

13. A method of route control in a communication network, comprising:
receiving first filter instructions, from a given router, requesting a blockage of route reporting for routing paths between a first autonomous system and a second autonomous system which are inferior to a first routing path threshold;
first determining whether to report known routes to the given router based on the first filter instructions; and
receiving second filter instructions, from the given router, the received second filter instructions requesting a modification to the first filter instructions.

14. The method of claim 13, wherein the second filter instructions request a blockage of route reporting for routing paths between the first autonomous system and the second autonomous system which are inferior to a second routing path threshold different from the first routing path threshold.

15. The method of claim 13, further comprising:
selectively reporting routes based on the first determining step.

16. The method of claim 14, further comprising:
second determining whether to report known routes based on the second filter instructions.

17. The method of claim 16, further comprising:
selectively reporting routes based on the second determining step.

18. The method of claim 13, wherein the first filter instructions include a first system identifier and a first path length and the second filter instructions include a second system identifier and a second path length.

19. The method of claim 18, further comprising:
second determining whether the first system identifier of the first filter instructions is the same as the second system identifier of the second filter instructions.

20. The method of claim 19, further comprising:
replacing the first filter instructions with the second filter instructions if the second determining step determines that the first and second system identifiers are the same, and the second path length is less than the first path length; and
activating the second filter instructions without replacing the first filter instructions if the second determining step determines that the first and second system identifiers are not the same.

21. The method of claim 13, wherein the second filter instructions request that the first filter instructions be withdrawn such that the first determining step is no longer performed.

22. The method of claim 21, further comprising:
deactivating the first filter instructions in response to the second filter instructions.
